(19) United States
(12) Patent Application Publication
(10) Pub. No.: US 2002/0168177 A1
(43) Pub. Date: Nov. 14, 2002

(54) Program recording system and program recording method

(75) Inventor: Ichiro Kajitani, Anpachi-gun (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Sanyo Electric Co., Ltd.

(21) Appl. No.: 10/016,471

(22) Filed: Dec. 10, 2001

(30) Foreign Application Priority Data
Dec. 11, 2000 (JP) JP A 2000-376582

(51) Int. Cl. H04N 5/91; H04N 7/00

(52) U.S. Cl. 386/83; 386/46

(57) ABSTRACT

A program recording system includes a home server which serves as a main controller, and a recording apparatus which is in charge of recording programs. When a confirmation request receiving unit receives a request for confirmation of contents of a program that is then being broadcast, from a remote user, an image acquiring unit instructs a capturing unit to capture an image of the program being currently on the air. The captured image is sent to the user by an image transmission processor. When a recording request receiving unit receives a recoding request from the user, a recording instructing unit gives a program storage an instruction to record the program. A free-run recording unit continuously records the program in the endless manner, and the program storage stores the program, from its broadcast start time retroactively, whose recording has been requested.

### BACKGROUND OF THE INVENTION

1. Field of the Invention

The present invention relates to a network system and it particularly relates to a technology for controlling the recording of broadcasting programs from a remote location.

2. Description of the Related Art

In recent years, a growing number of video decks have been finding their way into private homes, featuring increasingly high quality and multiple functions. Along with the effort to realize a greater multiplicity of functions, attempts have also been made to simplify necessary operations, such as the selection of a program to be recorded and the setting of a program recording reservation or presetting or recording. For example, Japanese Patent Application Laid-Open No. Hei06-133084 discloses a technology for easily grasping the contents of TV programs. Moreover, Japanese Patent Application Laid-Open No. Hei06-290510 discloses a recording apparatus capable of effecting the reservation of a recording with the press of a button.

On the other hand, so-called home networks that connect various electrical appliances at home by a network are now being installed, and as a result, it is now becoming possible to access any of the electrical appliances at home from remote locations by utilizing a terminal such as a portable telephone and so forth. Using this technology, therefore, one can make a reservation for recording TV programs from a location away from home. It is also possible to select a program to be recorded from the Electronic Program Guide (hereinafter referred to as EPG).

However, there are cases when the contents of TV programs cannot be grasped readily from the information provided by the EPG alone. In such cases, it would be very convenient if programs can be selected by some simpler method. In particular, at remote locations away from home, the terminals that can be used may be subject to functional limitations. For many people, program selection is often done by switching the channels while TV is on. And this mode of selection is more intuitive than the program selection using the EPS.

### SUMMARY OF THE INVENTION

The present invention has been made in view of the foregoing circumstances and an object thereof is to provide a technology that allows video recording by a highly expedient operation method from remote locations.

A preferred embodiment of the present invention relates to a program recording system. This system includes: a confirmation request receiving unit which receives a request for confirmation, which may be “preview”, of contents of a program being broadcast from a remote user; a capturing unit which captures at least one scene of the program according to the confirmation request; an image transmission processor which transmits the captured image to a terminal of the user; a recording request receiving unit which receives a request for recording the program from the user; and a recording instructing unit which instructs a recording of the program according to the recording request.

This system may form a part or the whole of a home network interconnecting various electric appliances, which is structured, for instance, in a home. This system may also be structured by a single electric appliance which has multiple functions in it.

Here, the “remote user” is a user who operates a terminal, such as a portable telephone, which can access into his/her home from a remote location away from home. “Remote” here should be understood to include not only locations outside one's home but also another room inside the house from which an access is attempted. “Capture” is, for instance, to take a still picture of a TV image at any arbitrary moment. It is assumed that the image is sent to a portable terminal such as a portable telephone, so that such a shaping process as compression or changing the aspect ratio may be performed on the still picture of the TV.

According to this system in the present invention, the contents of a program being currently broadcast can be confirmed from a remote location by the use of a captured image. The user, who can see an actual TV image, can grasp the contents of the program more intuitively than by consulting the table of programs.

In another preferred embodiment, a program recording system according to the present invention, includes; an electronic program guide (EPG) storage which stores an extended EPG formed by adding to an EPG a guide image indicating contents of a program; a confirmation request receiving unit which receives a request for confirmation of the contents of the program, from a remote user; an image acquiring unit which acquires the guide image corresponding to the program for which the confirmation request made, from the extended EPG; an image transmission processor which transmits the acquired guide image to a terminal of the user; a recording request receiving unit which receives a request for recording the program from the user; and a recording instructing unit which instructs a program recording according to the recording request.

It is to be noted that “Electronic Program Guide,” or EPG, means digitized data to be used to display on a screen such as a computer monitor or the like the table of TV programs, the program guide and such other information.

This system may further include a recording unit which records on a recording medium the program whose recording has been requested, according to the recording instruction. And the recording unit may include a free-run recording unit which is capable of recording a program being broadcast continuously in an endless manner; and a program storage which stores a program, from a start point by going back thereto, whose recording has been instructed.

Here, the “endless manner” is a rotational method in which, whenever a recording has used up all the remaining capacity of the area allotted for recording on a hard disk or other recording medium, the overwriting is effected in sequence from an area which has recorded a head portion of the recorded images. And “store” means a processing to protect a program whose recording has been specified by the user against the overwrite in the endless manner or a processing to duplicate the program and store it in another area.

Still another preferred embodiment according to the present invention relates to a program recording method. This method includes: receiving a request fox confirmation of contents of a program that is being broadcast, from a remote user; acquiring an image which indicates the contents of the program according to the confirmation request; transmitting the indicating image to a terminal of the user; receiving a request for recording the program from the user; and recording the program according to the recording request.

Still another preferred embodiment according to the present invention relates to a program recording system comprising a main controller and a recording apparatus both of which are connected to each other via a local area network. The main controller is a server (hereinafter referred to as “home server”) which supervises the control of various electric appliances in a home network. The main controller may be in charge of roles to receive a confirmation request for the contents of a program, transmit a captured image, store the EPG, transmit a guide image, receive a recording request for the program, and so forth. The recording apparatus may be in charge of roles to capture and record the program.

Moreover, any arbitrary combination of the above-described structural components as well as expressions, in the present invention, applied as or substituted between a method, an apparatus, a system, a recording medium, a computer program and so forth are still effective as and encompassed by embodiments of the present invention.

Moreover, this summary of the invention does not necessarily describe all necessarily features so that the invention may also be sub-combination of these described features.

### BRIEF DESCRIPTION OF THE DRAWINGS

FIG. 1 shows a general configuration of a network system according to a first embodiment of the present invention.

FIG. 2 shows a structure of a home server and the recording apparatus according to the embodiment of the present invention.

FIG. 3 shows a data structure of an extended EPG.

FIG. 4 is a flowchart showing an operation procedure of a program recording system according to the embodiment of the present invention.

FIG. 5 is a flowchart showing a communication procedure between a portable terminal, a home server and a recording apparatus.

FIG. 6 shows an example of a display of the portable terminal which sets a confirmation request.

FIG. 7 is an example of a display of a portable terminal showing a captured image.

FIG. 8 shows an example of a display showing a program guide that uses an EPG.

FIG. 9 shows a structure of a program recording system according to a second embodiment of the present invention.

### DETAILED DESCRIPTION OF THE INVENTION

The invention will now be described based on the preferred embodiments, which do not intend to limit the scope of the features and the combinations thereof described in the embodiment are not necessarily essential to the invention.

A program recording system according to a preferred embodiment of the present invention sends a guide image that hints the contents of a program to a portable terminal of a remote user in response to his/her request. At a request for confirmation of the contents of a program now being broadcast, the program recording system captures a program image and sends the program image to the user's portable terminal Thus, the user can intuitively grasp the contents of the program currently on the air.

The user who has confirmed the captured image on his/her portable terminal can send a request for recording the program to the program recording system. The program recording system records the program in response to the recording request. This system, which is recording TV programs by an endless manner, can store a program from its start retroactively even when a recording request is made for a program now on the air. Thereby, a program currently being broadcast can be easily stored.

First Embodiment

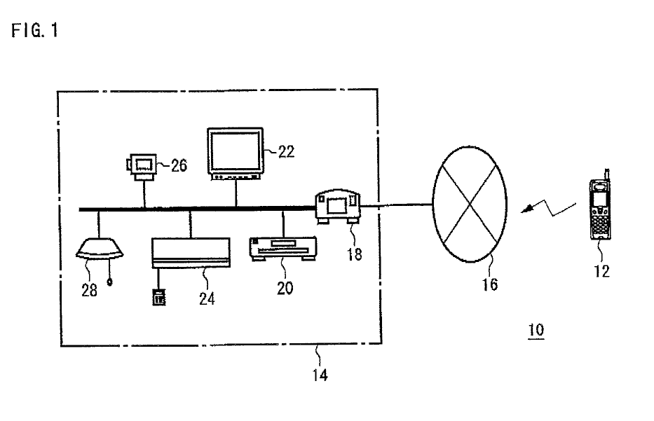

FIG. 1 shows a general configuration of a network system 10 according to a first embodiment of the present invention. The network system 10 is structured by connecting a remote portable terminal 12 with a home network 14 via the Internet 16. The home network 14 includes a home server 18, a recording apparatus 20, a television receiver 22, an air conditioner 24, a video camera 26 and a lighting fixture 28. Electrical appliances constituting the home network 14 are each connected to a local area network. The home server 18 not only plays the role of a main controller controlling each of the electric appliances but also serves as the window for communication with the portable terminal 12 via the Internet 16. The home server 18 may, for instance, have an http server function.

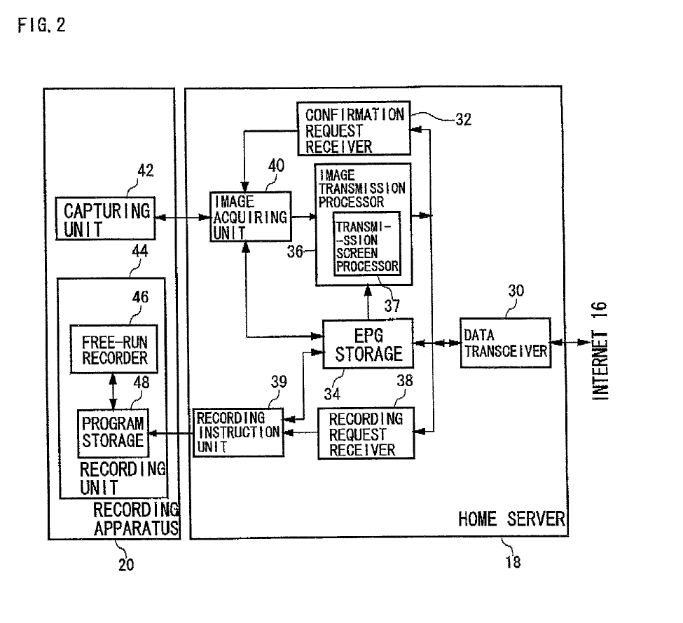

FIG. 2 shows a structure of home server 18 and the recording apparatus 20. The home server 18 includes a data transceiver 30 which transmits data to and receives data from the remote portable terminal 12. Data transmitted and received by the data transceiver 30 are handled by respective functional blocks constituting the home server 18.

The home server 18 further includes a confirmation request receiving unit 32, an EPG (Electronic Program Guide) storage 34 and an image acquiring unit 40. The EPG storage 34 stores an extended EPG formed by adding a guide image hinting the contents of a program to the EPG. The EPG storage 34 may update its information by acquiring an extended EPS from a predetermined EPG server via the data transceiver 30. The confirmation request receiving unit 32 receives a request for confirmation of the contents of a program from the remote user. The confirmation request receiving unit 32 receives information specifying which of the programs the confirmation request is directed to. For example, the confirmation request receiving unit 32 may accept the input of a channel number and the date and time of a broadcast.

The image acquiring unit 40 specifies the program for which a confirmation request has been made, based on the information received from the confirmation request receiving unit 32 while referring to the extended EPG stored in the EPG storage 34. The image acquiring unit 40 acquires a guide image corresponding to the specified program, from the extended EPG stored in the EPG storage 34. Then, if the program for which the confirmation request is made is currently on the air, the image acquiring unit 40 acquires an image capturing at least one scene of the program in substitution for a guide image which is to be acquired from the EPG storage 34. In such a case, the image acquiring unit 40 sends a capturing instruction to the recording apparatus 20. Moreover, even when the confirmation request is made for a program currently on the air, an arrangement may be implemented such that a captured image should be used only when the guide image for the program is not contained in the extended EPG.

The recording apparatus 20 includes a capturing unit 42. The capturing unit 42 captures at least one scene of a program being broadcast according to the confirmation request received from the home server 18. The captured image is transferred to the image acquiring unit 40, and the image acquiring unit 40 may have the captured image undergo such a reshaping processing as compression or aspect ratio change as required.

The home network 14 further includes an image transmission processor 36. The image transmission processor 36 performs the preprocessing of the guide image or captured image received From the image acquiring unit 40, so as to be transmitted to the portable terminal 12. The image transmission processor 36 includes a transmission screen processor 37. The transmission screen processor 37 prepares layout data for displaying the guide image or captured image on the screen of the portable terminal 12. The layout data may be prepared using text data described in page description language such as HTML (Hyper Text Markup Language) or CHTML (Compact HTML). Address information on the image to be transmitted may be described in this layout data. Moreover, information, such as a program guide corresponding to the image to be transmitted, which is to be received from the EPG storage 34, may be described in this layout data. The image transmission processor 36 which includes the transmission screen processor 37, transmits the image data and text data at their respective timings to the portable terminal 12 via the data transceiver 30. The portable terminal 12 makes a screen display by combining the image data and text data according to the received layout data. The user can quickly grasp the contents of the program by seeing the captured image or the guide image.

The home server 18 further includes a recording request receiving unit 38 and a recording instructing unit 39. The recording request receiving unit 38 receives a request for recording a program from the portable terminal 12=For example, the user sets the channel and the date and time of broadcasting of a program whose recording he/she desires. When the program whose recording he/she desires is currently on the air, the user may set either “NOW” or the broadcast starting time as the recording start time. If the “NOW” F is selected, the recording instructing unit 39 will set the broadcast starting time of the program as the recording start time retroactively. Then, the recording instructing unit 39 may refer to the extended EPG held in the EPG storage 34 in order to acquire the broadcast starting time. The recording instructing unit 39 instructs the recording apparatus to carry out the program recording or the program recording reservation according to the recording request made. For example, the recording instructing unit 39 gives a “recording” instruction when the recording request is for a program now being broadcast while the recording instructing unit 39 gives a “recording reservation” instruction when it is for a program to be broadcast in the future.

The recording apparatus 20 further includes a recording unit 44 that records a program on a recording medium. The recording medium may, for example, be a magnetic disk medium or a magnetic tape medium. The recording unit 44 records or reserves the recording of a program whose recording has been requested, according to the instruction from the recording instructing unit 39.

The recording unit 44 includes a free-run recording unit 46 and a program storage 48. The free-run recording unit 46 records a program being broadcast continuously in an endless manner. Then, the program storage 48 stores a program whose recording has been instructed. The method for storing a program may be such that the program may be protected against overwrite by the recording in the endless manner or may be duplicated and stored in another area. Moreover, it is to be noted that in the endless manner recording, recorded images remain for a certain length of time until they are overwritten. Hence, when a recording instruction is given for a program currently on the air, the entire program can be stored retroactively by acquiring the program images from the start point of the program.

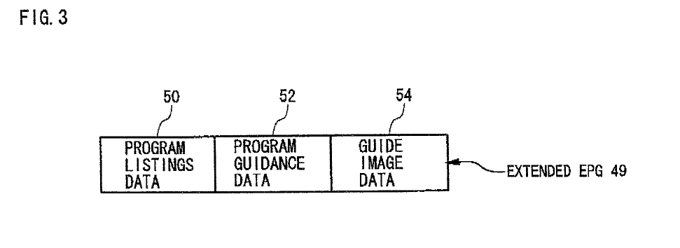

FIG. 3 shows a data structure of an extended EPG. The extended EPG 49 includes and is constituted principally by program listing data 50, program guidance data 52 and guide image data 54. The program listings data 50 is program listings information, such as the TV programs columns from a newspaper, and may include such data as the date and time of broadcasting, the channel and the title of the program. The program guidance data 52 is information describing the contents of a program and may include such data as the outline of the program, the cast and the producer. The guide image data 54 is an image that hints, implies or indicates the contents of a program. For example, a climactic scene of the already recorded program of a drama or movie may be used as a guide image. With live broadcasting, a past image of the newscaster or emcee or an image of the past game of sport may be used as a guide image. It is to be appreciated here, however, that the guide image may not necessarily represent the whole of a program.

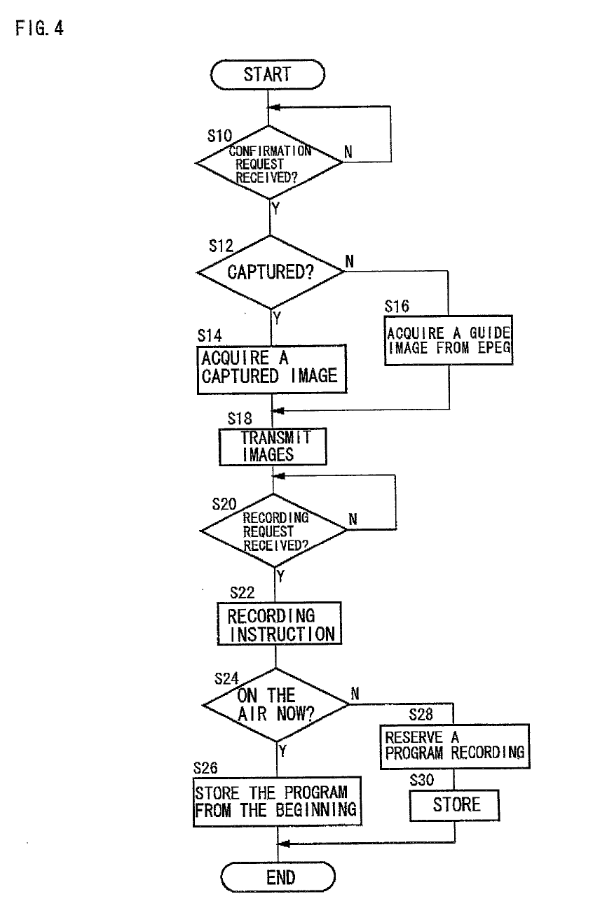

FIG. 4 is a flowchart showing an operation procedure of the program recording system. First the confirmation request receiving unit 32 waits for a request for confirming the contents of a program transmitted from a remote portable terminal 12 (S10). when the confirmation request receiving unit 32 has received a confirmation request (S10Y), the image acquiring unit 40 decides whether or not to capture a scene in the program now on the air as an image to be sent back to the user (S12). If the image acquiring unit 40 instructs an image capturing (S12Y), the capturing unit 42 will capture an image of the program being broadcast and the image acquiring unit 40 will acquire the captured image (514). On the other hand, if the decision in S12 is “No” to capturing (S12N), then the image acquiring unit 40 will acquire a guide image from the extended EPG (S16). Then the image transmission processor 36 will transmit either the captured image or the guide image to the portable terminal 12 (S18).

Next, the recording request receiving unit 38 waits for a program recording request transmitted from the portable terminal 12 (S20) When the recording request receiving unit 38 has received a recording request (S20Y), the recording instructing unit 39 instructs the recording unit 44 to record the program or reserve a recording of the program (S22). Then if the recording instruction is for a program now on the air (S24Y), the program will be stored retroactively from the starting time of the program (S26). On the other hand, if the recording instruction is for a program not yet broadcast (S24N), the program recording will be reserved (S28) and the program will be stored after the broadcast (S30).

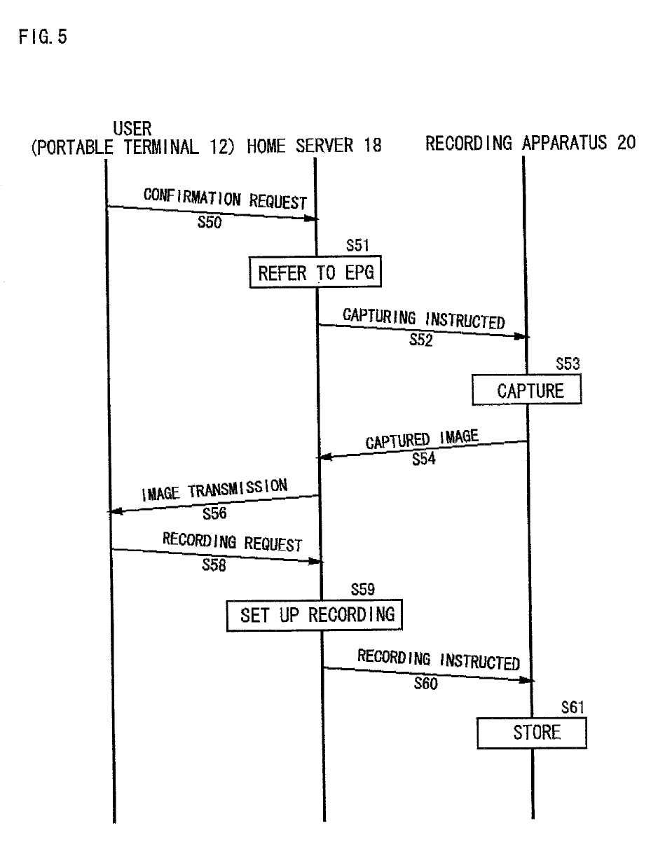

FIG. 5 is a flowchart showing a communication procedure between a portable terminal, a home server and a recording apparatus. First the remote portable terminal 12 transmits a request for confirming the contents of a program to the home server 18 (S50). Then the home server 18 refers to the extended EPG (S51) and decides whether the program for which the confirmation request has been made is currently being broadcast or not. Then if the program is now on the air, the home server 18 instructs the recording apparatus 20 to capture an image of the program (S52). Upon this, the recording apparatus 20 captures the image (S53) and then sends the captured image back to the home server 18 (S54). Then the home server 18 transmits the captured image to the portable terminal 12 (S56).

Next, the portable terminal 12 transmits a request for recording the program to the home server 18 (S58). Then the home server 18 sets the recording conditions, such as the date and time of broadcasting and the channel, according to the recording request (S59) and sends out a recording instruction 10 the recording apparatus 20 (s60). Next, the recording apparatus 20 stores the program according to the recording instruction (S61).

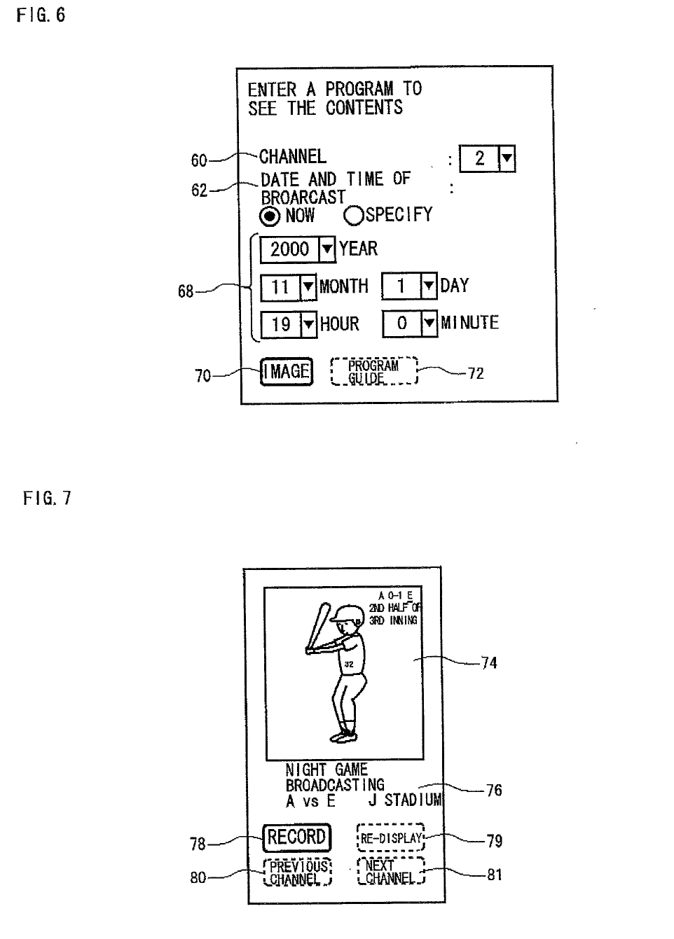

FIG. 6 shows an example of a display of a portable terminal which sets a confirmation. The display includes a channel setting 60 and a broadcast date and time setting 62. The broadcast date and time setting 62 allows a selection between “Now” and “Specify”. With “Specify” selected, the display allows the entry of a chosen date and time in the date and time setting 68. With “Now” selected, the program now on the air will be set. Then, clicking an image button 70 will display a captured image of the program now on the air if “Now” is the selection, or a guide image if “Specify” is the selection. Clicking a program guide button 72 will display an EPG corresponding to the channel setting 60 and the broadcast date and time setting 62.

FIG. 7 is an example of a display of a portable terminal showing a captured image. As a captured image 74, an image from a night game broadcast is shown in FIG. 7. Displayed below the image are the characters for a program caption 76. Clicking a record button 79 will transmit a request for recording the program. Clicking a re-display button 79 will have the captured image 74 updated by a newly captured image. Clicking a previous channel button 80 will switch the display to the captured image for the previous channel. Clicking a next channel button 81 will switch the display to the captured image for the next channel. Thereby, the user can select a program to be recorded in the same manner as he/she selects a desired program by switching channels on the television.

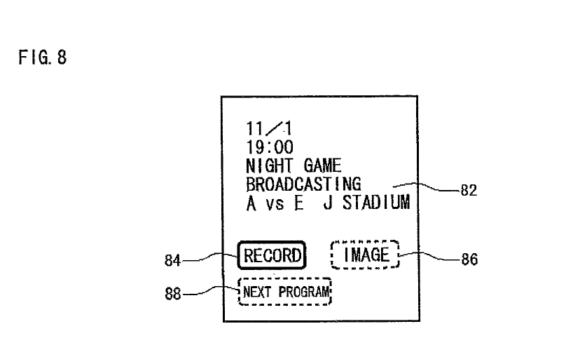

FIG. 8 shows an example of a display showing a program guide that uses an EPG. A program caption 82 displays the date and time and so forth of a “Night Game Broadcasting”. Clicking a record button 84 will transmit a request for recording the program. Clicking an image button 86 will display a captured image or a guide image. Clicking a program switching “Next Program” button 88 will display the contents of a program scheduled for the next period of time of the same channel.

Second Embodiment

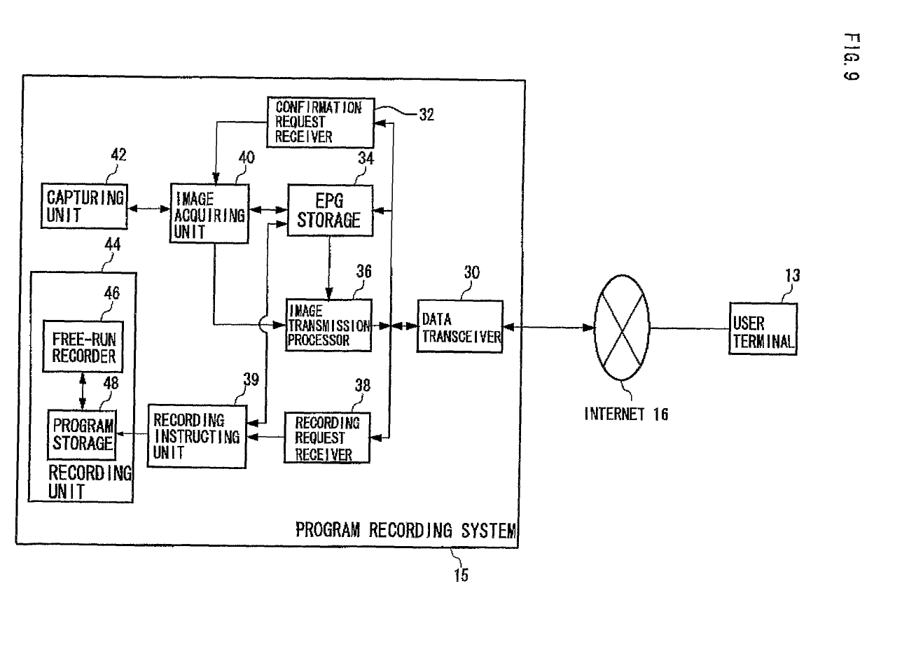

FIG. 9 shows a structure of a program recording system according to a second embodiment of the present invention. A program recording system 15 according to the second embodiment is a system that combines into a single apparatus the functions of the home server 18 and the recording apparatus 20 according to the first embodiment. This program recording system 15 is connected to a user terminal 13 via the Internet 16. The user terminal 13 may be a portable terminal, such as a portable telephone, and may also be a terminal, such as a personal computer, connected to the Internet. Respective functional blocks constituting the program recording system 15 have the same functions as the respective functional blocks constituting the home server 18 and the recording apparatus 20 according to the first embodiment.

Thus, realized is an intelligent recording apparatus with the remote access function, the image capturing function and the retroactive recording function, which can also be used in homes not yet equipped with any home network.

The present invention has been described based on the embodiments which are only exemplary. It is understood by those skilled in the art that there exist other various modifications to the combination of each component and each processing described and that such modifications are encompassed by the scope of the present invention. Some of the modifications will be described here.

In the present embodiments, a selection is made between a captured image and a guide image as the image to be sent back to the remote user who has sent the request for confirming the contents of a program. An arrangement according to one modification may be such that a captured image is always sent back to the user or that a guide image is always sent back to the user.

In the present embodiments, the recording apparatus 20 has the function for capturing a program image. As another modification, the home server 18 may have this function, instead.

As still another modification, the capturing unit 42 may have a function for judging whether the image now on the air is a CM (commercial message) or not. Moreover, the modification may be such that when a confirmation request has been made during a CM broadcast, a guide image may be acquired from an extended EPG and sent back to the user.

Moreover, even when the confirmation request is made for a program the entire of which has already been broadcast, the arrangement may be such that the program can be stored so long as it has not been overwritten in the endless manner. The larger the capacity of a recording medium that records programs, the lesser the chance of being overwritten and therefore the greater the probability will be for the already broadcast programs to be stored.

Moreover, the confirmation request receiving unit 32, the image acquiring unit 40 and the image transmission processor 36 may be organized by a CGI (Common Gateway Interface). In this case, this CGI receives a program confirmation request from the portable terminal 12 and sends back a response in HTML data. Similarly, the recording request receiving unit 38 and the recording instructing unit 39 may be organized by a CGI. In this case, a recording request button on the display of a portable terminal may, for instance, have a function for transmitting information necessary for a recording request as an argument, and according to the argument, the CGI may acquire program information from the EPG storage and send a recording instruction to the recording apparatus 20. Then the response to the portable terminal 12 may be sent back in HTML data.

According to the present embodiments, the contents of a program are confirmed from a remote location by a highly expedient method.

Although the present invention has been described by way of exemplary embodiments, it should be understood that many changes and substitutions may be made by those skilled in the art without departing from the scope of the present invention which is defined by the appended claims.

What is claimed is:

1. A program recording system, comprising:
a confirmation request receiving unit which receives a request for confirmation of contents of a program that is being broadcast, from a remote user;
a capturing unit which captures at least one scene of the program according to the confirmation request;
an image transmission processor which transmits a thus captured image to a terminal of the user;
a recording request receiving unit which receives a request for recording the program from the user; and
a recording instructing unit which instructs a recording of the program recording according to the recording request.

2. A program recording system, comprising:
an electronic program guide (EPG) storage which stores an extended EPG formed by adding to an EPG a guide image indicating contents of a program;
a confirmation request receiving unit which receives a request for confirmation of the contents of the program, from a remote user;
an image acquiring unit which acquires the guide image corresponding to the program for which the confirmation request was made, from the extended EPG;
an image transmission processor which transmits the acquired guide image to a terminal of the user;
a recording request receiving unit which receives a request for recording the program from the user; and
a recording instructing unit which instructs a recording of the program according to the recording request.

3. A program recording system according to claim 2, wherein said image acquiring unit 40 acquires an image capturing at least one scene of the program, as a substituted guide image, when the confirmation request is made for the program which is currently being broadcast.

4. A program recording system according to claim 3, wherein the guide image is acquired from said EPG storage so as to be transmitted to the terminal of the user in the event that the program is in the midst of a commercial message.

5. A program recording system according to claim 2, wherein said confirmation request receiving unit, image acquiring unit and image transmission processor are organized by a common gateway interface (CGI), whereby the CGI receives the confirmation request from the terminal of the remote user and sends back a response thereto in HTML format.

6. A program recording system according to claim 2, wherein said recording request receiving unit and said recording instructing unit are organized by a common gateway interface (CGI), whereby a recording request button on display of the terminal of the remote user has a function for transmitting information necessary for the recording request as an argument, so that according to the argument the CGI acquires program information from the EPG storage.

7. A program recording system according to claim 1, further comprising a recording unit which records on a recording medium the program whose recording has been requested, according to the recording instruction,
wherein said recording unit includes a free-run recording unit which records a program being broadcast continuously in an endless manner; and a program storage which stores a program, from a start point of the program retroactively, whose recording has been instructed.

8. A program recording system according to claim 2, further comprising a recording unit which records on a recording medium the program whose recording has been requested, according to the recording instruction,
wherein said recording unit includes a free-run recording unit which records a program being broadcast continuously in an endless manner; and a program storage which stores a program, from a start point of the program retroactively, whose recording has been instructed.

9. A program recording system according to claim 3, further comprising a recording unit which records on a recording medium the program whose recording has been requested, according to the recording instruction,
wherein said recording unit includes a free-run recording unit which records a program being broadcast continuously in an endless manner; and a program storage which stores a program, from a start point of the program retroactively, whose recording has been instructed.

10. A program recording method, comprising:
receiving a request for confirmation of contents of a program that is being broadcast, from a remote user;
acquiring an image which indicates the contents of the program according to the confirmation request;
transmitting the program-indicating image to a terminal of the user;
receiving a request for recording the program from the user; and
recording the program according to the recording request.

11. A method according to claim 10, wherein an image capturing at least one scene of the program is acquired as a substituted program-indicating image in said acquiring, when the confirmation request is made for the program which is currently being broadcast or the program-indicating image is not available.

12. A method according to claim 11, wherein the program-indicating image is acquired from an electronic program guide (EPG) so as to be transmitted to the terminal of the user in the event that the program is in the midst of a commerce al message.

13. A program recording system comprising a main controller and a recording apparatus both of which are connected to each other via a local area network,
said main controller comprising:
a confirmation request receiving unit which receives a request for confirmation of contents of a program being broadcast, from a remote user;
an image acquiring unit which instructs said recording apparatus, according to the confirmation request, to capture at least one scene of the program and acquires a thus captured image;
an image transmission processor which transmits the captured image to a terminal of the user;
a recording request receiving unit which receives a request for recording the program from the user; and
a recording instructing unit which instructs said recording apparatus to record the program according to the recording request, and
said recording apparatus comprising:
a capturing unit which captures the at least one scene of the program according to a capturing instruction and sends a thus captured image to said image acquiring unit; and
a recording unit which records the program on a recording medium according to the recording instruction.

14. A program recording system according to claim 13, wherein said main controller and said recording system are integrated into a single system.

15. A program recording system comprising a main controller and a recording apparatus both of which are connected to each other via a local area network,
said main controller comprising:
an electronic program guide (EPG) storage which stores an extended EPG formed by adding to an EPG a guide image implying contents of a program;
a confirmation request receiving unit which receives a request for confirmation of the contents of the program, from a remote user;
an image acquiring unit which acquires the guide image corresponding to the program for which the confirmation request was made, from the extended EPG;
an image transmission processor which transmits the acquired guide image to a terminal of the user;
a recording request receiving unit which receives a request for recording the program from the user; and
a recording instructing unit which instructs a recording of the program recording according to the recording requests and
said recording apparatus including:
a recording unit which records the program on a recording medium according to the recording instruction.

16. A program recording system according to claim 15, wherein said main controller and said recording system are integrated into a single system.
